(19) United States
(12) Patent Application Publication
(10) Pub. No.: US 2016/0039292 A1
(43) Pub. Date: Feb. 11, 2016

(54) BRAKE CONTROL DEVICE FOR VEHICLE

(71) Applicants: Yu TAKAHASHI, Aichi (JP); TOYOTA JIDOSHA KABUSHIKI KAISHA, Aichi (JP)

(72) Inventor: Yu TAKAHASHI, Toyota-shi (JP)

(73) Assignee: TOYOTA JIDOSHA KABUSHIKI KAISHA, Toyota-shi, Aichi (JP)

(21) Appl. No.: 14/783,235

(22) PCT Filed: Apr. 9, 2013
(86) PCT No.: PCT/JP13/60672

§ 371 Date: Oct. 8, 2015

(51) Int. Cl. B60L 7/24; B60W 10/08; B60W 10/188; B60T 8/172

(52) U.S. Cl. CPC B60L 7/24; B60T 8/172; B60W 10/08; B60W 10/188; B60W 2710/182

(57) ABSTRACT

A brake ECU110 memorizes a deceleration A of a vehicle body when a braking mode is shifted from a regenerative braking mode to a cooperative braking mode (S31). The brake ECU110 memorizes a deceleration B at the time of shifting to a friction braking mode, when the braking mode is shifted from the cooperative braking mode to a friction braking mode in a status that a brake operation is retained constant (S32 to S37). The brake ECU110 computes a deceleration ratio α by dividing the deceleration A by the deceleration B, and updates the deceleration ratio α (S39). The brake ECU110 corrects a target fluid pressure P* using this deceleration ratio α (P*=P*×α). Thereby, a fluctuation of the deceleration at the time of a transition of a braking mode can be suppressed.

### TECHNICAL FIELD

The present invention relates to a brake control device for a vehicle which generates a regenerative braking force and a friction braking force.

### BACKGROUND ART

A brake control device for a vehicle comprising a regenerative braking device which makes a wheel generate a regenerative braking force by converting a kinetic energy of the wheel into an electrical energy and a friction braking device which makes a wheel generate a friction braking force by a friction with a brake pad has been conventionally known. Such a brake control device sets a target deceleration of a vehicle body based on an amount of a brake operation, and sets a target braking force corresponding to this target deceleration. This target braking force is distributed to a target regenerative braking force which is a required braking force for the regenerative braking device and a target friction braking force which is a required braking force for the friction braking device.

Generally, in order to effectively use a regenerative braking force, when a target braking force can be acquired only by a regenerative braking force, a target friction braking force is set as zero, and a target regenerative braking force is set as the same value as the target braking force. On the other hand, when a target braking force cannot be acquired only by a regenerative braking force, the shortfall is assigned as a target friction braking force. Moreover, in a status where a regenerative braking force cannot be generated, such as a case when a vehicle speed is low, a target regenerative braking force is set as zero, and a target friction braking force is set as the same value as a target braking force. A braking mode which generates only a regenerative braking force is referred to as a regenerative braking mode, a braking mode which generates only a friction braking force is referred to as a friction braking mode, and a braking mode which generates both the regenerative braking force and the friction braking force cooperatively is referred to as a cooperative braking mode.

In the process in which a vehicle speed falls due to a brake operation by a driver, a braking mode shifts from a regenerative braking mode to friction braking mode through a cooperative braking mode. For instance, when a brake operation is performed while a vehicle is running with a vehicle speed at which a sufficient regenerative braking force can be generated, a regenerative braking mode will be performed at the beginning. Then, when it becomes impossible to generate a target braking force only by a regenerative braking force with a decreasing vehicle speed, it will be switched to a cooperative braking mode from the regenerative braking mode, and a friction braking force will come to be added to a regenerative braking force. When the vehicle speed furthermore falls, it will be switched from the cooperative braking mode to a friction braking mode, and braking of a wheel will be performed only by a friction braking force.

A friction braking force is generated by pushing a brake pad against a brake disc rotor, and depends on the friction coefficient between the brake pad and the brake disc rotor. Moreover, the friction coefficient of such a friction member (brake pad and brake disc rotor) changes in accordance with aging, a temperature and humidity, etc. For this reason, even if a driver is doing a certain brake operation, when a braking mode shifts from a regenerative braking mode friction to a braking mode, the deceleration of a vehicle body may be changed to give a sense of discomfort to the driver.

To this issue, the brake control device proposed in Patent Document 1 (PTL1) calculates a correction coefficient based on a reference deceleration of a vehicle body computed based on the amount of a brake operation under execution of a friction braking mode and an actual deceleration, and corrects the control amount of friction braking with this correction coefficient.

### CITATION LIST

### Patent Literature

[PTL1] Japanese Patent Application Laid-Open (kokai) No. 2003-127721

### SUMMARY OF INVENTION

However, since the above-mentioned reference deceleration of a vehicle body is a design deceleration on a specific vehicle-weight condition, even if the friction coefficient of an actual friction member is the same as a designed value, when an actual vehicle weight is different from an assumed design vehicle weight, a difference between a reference deceleration and an actual deceleration will occur and the control amount of friction braking will be corrected, for instance. On the other hand, since a regenerative braking force generates a braking force by power generation of a motor, it generates a stable braking force independent of a friction coefficient of a friction member. For this reason, in the brake control device proposed in Patent Document 1 (PTL1), it is difficult to maintain a balance between a braking force in a regenerative braking mode and a braking force in a friction braking mode. Therefore, the deceleration of the vehicle body will be changed at the time of transition from a regenerative braking mode to a friction braking mode.

The present invention has been conceived in order to solve the above-mentioned problem, and one of the objectives of the present invention is to suppress a fluctuation of the deceleration of a vehicle body at the time of the transition from a regenerative braking mode to a friction braking mode.

A feature of the present invention which solves the above-mentioned problem is in that a brake control device for a vehicle comprising a regenerative braking means (10) for making a wheel generate a regenerative braking force by converting a kinetic energy of the rotating wheel into an electrical energy and collecting the electrical energy in a battery, a friction braking means (100) for making a wheel generate a friction braking force by a friction using a friction member, and a mode switch means (110) for shifting a braking mode from a regenerative braking mode which generates a required braking force (F*) according to an amount of a brake operation only by said regenerative braking force to a friction braking mode which generates said required braking force only by said friction braking force, comprises a gap index acquisition means for acquiring a gap index (a) which shows a gap of a correlation between a required braking force and an actually obtained deceleration of a vehicle body at the time of an execution of said friction braking mode from a basis which is a correlation between a required braking force and an actually obtained deceleration of the vehicle body at the time of an execution of said regenerative braking mode (S31 to S39, S51 to S65), and a braking force correction means for correcting a target value of said friction braking force or said regenerative braking force based on said gap index so that said gap decreases (S17, S231).

The present invention comprises a regenerative braking measure, a friction braking measure and a mode switch means. The regenerative braking measure makes a wheel generate a regenerative braking force by converting a kinetic energy of the rotating wheel into an electrical energy and collecting the electrical energy in a battery. The friction braking measure makes a wheel generate a friction braking force by a friction using a friction member. The mode switch means shifts a braking mode from a regenerative braking mode which generates a required braking force according to an amount of a brake operation only by a regenerative braking force to a friction braking mode which generates the required braking force only by a friction braking force. In this case, it is preferable to interpose a cooperative braking mode which generates the regenerative braking force and the friction braking force cooperatively in the process of shifting from the regenerative braking mode to the friction braking mode. That is, it is preferable to shift the braking mode from the regenerative braking mode to the friction braking mode through the cooperative braking mode.

The regenerative braking force decreases with a decreasing vehicle speed. For this reason, it is necessary to shift the braking mode from the regenerative braking mode to the friction braking mode in the middle of a brake operation. The friction braking force changes with the friction coefficient of the friction member. On the other hand, regenerative braking force does not change with the friction coefficient of the friction member. For this reason, when the friction coefficient of the friction member changed, even if a driver is doing a constant brake operation, the deceleration of the vehicle body will be changed when the braking mode is shifted from the regenerative braking mode to the friction braking mode.

Then, the present invention comprises a gap index acquisition means and a braking force correction means. The gap index acquisition means acquires a gap index which shows a gap of a correlation between a required braking force and an actually obtained deceleration of a vehicle body at the time of an execution of the friction braking mode from a basis which is a correlation between a required braking force and an actually obtained deceleration of the vehicle body at the time of an execution of the regenerative braking mode. When the friction coefficient of the friction member changes, the correlation between the required braking force and the actually obtained deceleration of the vehicle body at the time of the execution of the friction braking mode changes. On the other hand, the correlation between the required braking force and the actually obtained deceleration of the vehicle body at the time of the execution of the regenerative braking mode is not affected by the change of the friction coefficient of the friction member. Therefore, the gap index shows the extent of the change of the deceleration of the vehicle body when the braking mode is shifted from the regenerative braking mode to the friction braking mode. Based on this gap index, the braking force correction means corrects a target value of the friction braking force or the regenerative braking force so that the gap decreases. In addition, correction of the target value of the friction braking force or the regenerative braking force is substantively the same as correction of the control amount for controlling the friction braking force or the regenerative braking force.

As a result, in accordance with the present invention, a fluctuation of the deceleration of a vehicle body at the time of the transition from a regenerative braking mode to a friction braking mode can be suppressed.

Another feature of the present invention is in that said gap index acquisition means acquires, as said gap index, a deceleration ratio (a) which shows the ratio of a deceleration (A) acquired at the time of the execution of said regenerative braking mode and a deceleration (B) acquired at the time of the execution of said friction braking mode under a common required braking force condition.

In accordance with the present invention, as the gap index, the deceleration ratio which shows the ratio of the deceleration acquired at the time of the execution of the regenerative braking mode and the deceleration acquired at the time of the execution of the friction braking mode under a common required braking force condition is acquired. Therefore, using this deceleration ratio, the target value of the friction braking force or regenerative braking force can be easily corrected.

Another feature of the present invention is in that the brake control device for a vehicle comprises a brake operation retention evaluation means (S32 to S34) for judging whether the braking mode is shifted from said regenerative braking mode to said friction braking mode in a status that a brake operation is retained constant, and that said gap index acquisition means (S31 to S39) calculates, as said deceleration ratio (a), the ratio of the deceleration (A) acquired at the time of the execution of said regenerative braking mode and the deceleration (B) acquired at the time of the execution of said friction braking mode at the time of a transition from said regenerative braking mode to said friction braking mode, when it is judged that the braking mode is shifted from said regenerative braking mode to said friction braking mode in a status that a brake operation is retained constant.

In the present invention, the brake operation retention evaluation means judges whether the braking mode is shifted from the regenerative braking mode to the friction braking mode in a status that a brake operation is retained constant. For instance, the brake operation retention evaluation means memorizes a threshold value for judging that the brake operation is retained, and judges whether the braking mode is shifted from the regenerative braking mode to the friction braking mode in a status that the change of the amount of the brake operation is maintained below the threshold value. Since the amount of a brake operation corresponds to a required braking force, it is substantially the same as judging whether the braking mode is shifted from the regenerative braking mode to the friction braking mode in a status that the change of the amount of the brake operation is maintained below the threshold value. And when it is judged that the braking mode is shifted from the regenerative braking mode to the friction braking mode in a status that a brake operation is retained constant, the gap index acquisition means calculates, as the deceleration ratio, the ratio of the deceleration acquired at the time of the execution of the regenerative braking mode and the deceleration acquired at the time of the execution of the friction braking mode at the time of the transition of the braking mode. Therefore, since the deceleration ratio is calculated and acquired at the time of a series of brake operations, a furthermore proper deceleration ratio can be acquired. For this reason, the target value of the friction braking force or regenerative braking force can be corrected furthermore properly.

Another feature of the present invention is in that the brake control device for a vehicle comprises a regeneration deceleration property acquisition means (S51 to S55) for sampling a plurality of data which shows a correlation of a required braking force and an actually obtained deceleration of a vehicle body to acquire a regeneration deceleration property which shows the property of an actual deceleration over a required braking force at the time of the execution of said regenerative braking mode, and a friction deceleration property acquisition means (S57 to S61) for sampling a plurality of data which shows a correlation of a required braking force and an actually obtained deceleration of a vehicle body to acquire a friction deceleration property which shows the property of an actual deceleration over a required braking force at the time of the execution of said friction braking mode, and that said gap index acquisition means calculates said deceleration ratio based on said regeneration deceleration property and said friction deceleration property.

In the present invention, the regeneration deceleration property acquisition means samples a plurality of data which shows the correlation of the required braking force and the actually obtained deceleration of the vehicle body at the time of the execution of the regenerative braking mode and acquires the regeneration deceleration property which shows the property of the actual deceleration over the required braking force. Moreover, the friction deceleration property acquisition means samples a plurality of data which shows the correlation of the required braking force and the actually obtained deceleration of the vehicle body at the time of the execution of the friction braking mode and acquires the friction deceleration property which shows the property of the actual deceleration over the required braking force. And, the gap index acquisition means calculates the deceleration ratio based on the regeneration deceleration property and the friction deceleration property. Therefore, the deceleration ratio can be calculated easily, without requiring a constant brake operation.

Although the symbols used in the embodiments are attached in parenthesis to the configurations of the invention corresponding to the embodiments in the above-mentioned explanation in order to help understanding of the invention, each constituent elements of the invention are not limited to the embodiments specified with the above-mentioned symbols.

### BRIEF DESCRIPTION OF DRAWINGS

FIG. 1 is a schematic system configuration diagram of the brake control device for a vehicle in the present embodiment.

FIG. 2 is a schematic configuration diagram of a hydraulic brake system.

FIG. 3 is a flowchart for showing a brake regeneration cooperative control routine.

FIG. 4 is a graph for showing a maximum regenerative braking force map.

FIG. 5 is a graph for showing transition of a regenerative braking force and a friction braking force.

FIG. 6 is a graph for showing transition of a braking force and transition of a deceleration.

FIG. 7 is a flowchart for showing a first embodiment of a deceleration ratio calculation routine.

FIG. 8 is a graph for showing transition of a pedal stroke.

FIG. 9 is a graph for showing transition of a deceleration.

FIG. 10 contains graphs for showing transitions of target fluid pressures, braking forces and decelerations with and without correction.

FIG. 11 is a flowchart for showing a second embodiment of the deceleration ratio calculation routine.

FIG. 12 contains graphs for showing sampling data.

FIG. 13 is a graph of a linear function showing a relation between an actual regenerative braking force and a deceleration.

FIG. 14 is a graph of a linear function showing a relation between a target friction braking force and a deceleration.

FIG. 15 is a flowchart for showing a learning value reset routine.

FIG. 16 is a flowchart for showing a modification of a brake regeneration cooperative control routine.

FIG. 17 contains graphs for showing transitions braking forces and decelerations with and without correction.

### DESCRIPTION OF EMBODIMENTS

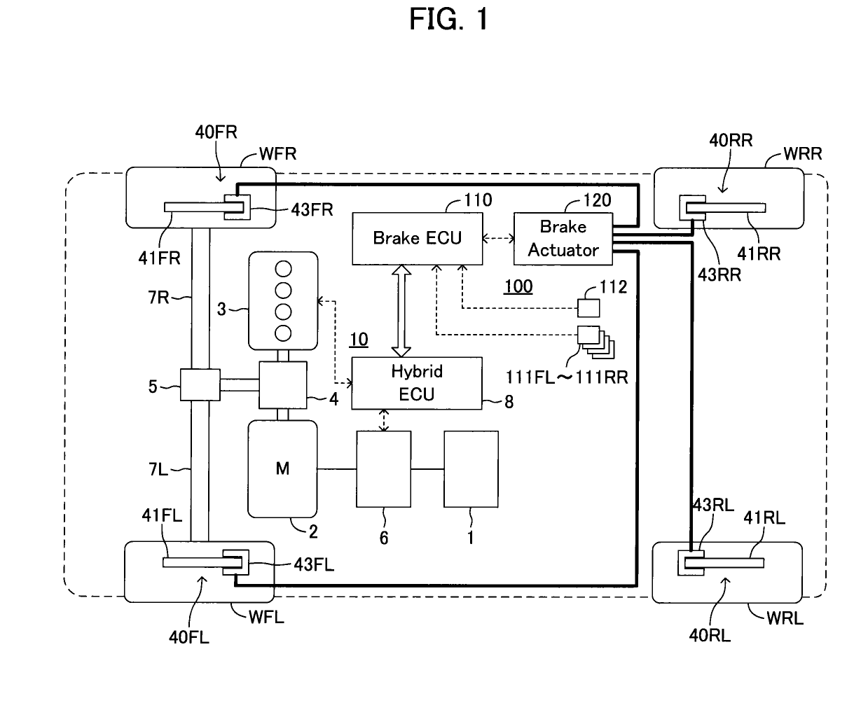

Hereafter, a brake control device for a vehicle according to one embodiment of the present invention will be explained using drawings. FIG. 1 is a schematic system configuration diagram of the brake control device for a vehicle according to the present embodiment.

The brake control device according to the present embodiment is applied to a front-wheel-drive-type hybrid vehicle comprising the hybrid system 10 which controls two kinds of power sources, i.e. the motor 2 to which an electric power is supplied from the battery 1 and the gasoline engine 3. The hybrid system 10 not only can use the motor 2 as a running power source for the vehicle, but can also make the right and left front wheels WFL and WFR generate a regenerative braking force by rotating the motor 2 using kinetic energy of the wheels to generate electricity and regenerating the generated electric power in the battery 1. The brake control device according to the present embodiment is constituted by this hybrid system 10 which can generate a regenerative braking force and the hydraulic brake system 100 which make the right and left front wheels WFL and WFR and right and left rear wheels WRL and WRR generate a friction braking force.

In the hybrid system 10, the output shaft of the gasoline engine 3 and the output shaft of the motor 2 are connected with the planetary gear 4. The rotation of the output shaft of the planetary gear 4 is transmitted to the axle shafts 7L and 7R for the right and left front wheels through the reducer 5 and, thereby, the right and left front wheel WFL and WFR are rotationally driven. The motor 2 is connected to the battery 1 through the inverter 6.

The drive control of the motor 2 and the gasoline engine 3 is carried out by the hybrid electronic control unit 8 (referred to as the hybrid ECU8). While the hybrid ECU8 comprises a microcomputer as a principal part, it is a control unit which has an input-output interface, a drive circuit, and a communication interface, etc., and is connected to the brake electronic control unit 110 (referred to as the brake ECU110) disposed in the hydraulic-brake system 100 so that they can communicate mutually. The hybrid ECU8 carries out the drive control of the gasoline engine 3 and the motor 2 based on the signals from the sensors (not shown) which detect the stepping-in amount of an accelerator pedal, the position of a shift lever and the charge status of the battery, etc.

Moreover, when the hybrid ECU8 receives a regenerative braking request command transmitted from the brake ECU110, it operates the motor 2 as a generator to generate a regenerative braking force. That is, the hybrid ECU8 makes the motor 2 generate electricity by transmitting the kinetic energy of the rotating wheel to the output shaft of the motor 2 through the axle shafts 7L and 7R for front wheels, the reducer 5 and the planetary gear 4 to rotate the motor 2, and collect the generated electric power in the battery 1 through the inverter 6. At this time, the braking torque generated by the motor 2 is used as braking torque of the front wheels WFL and WFR.

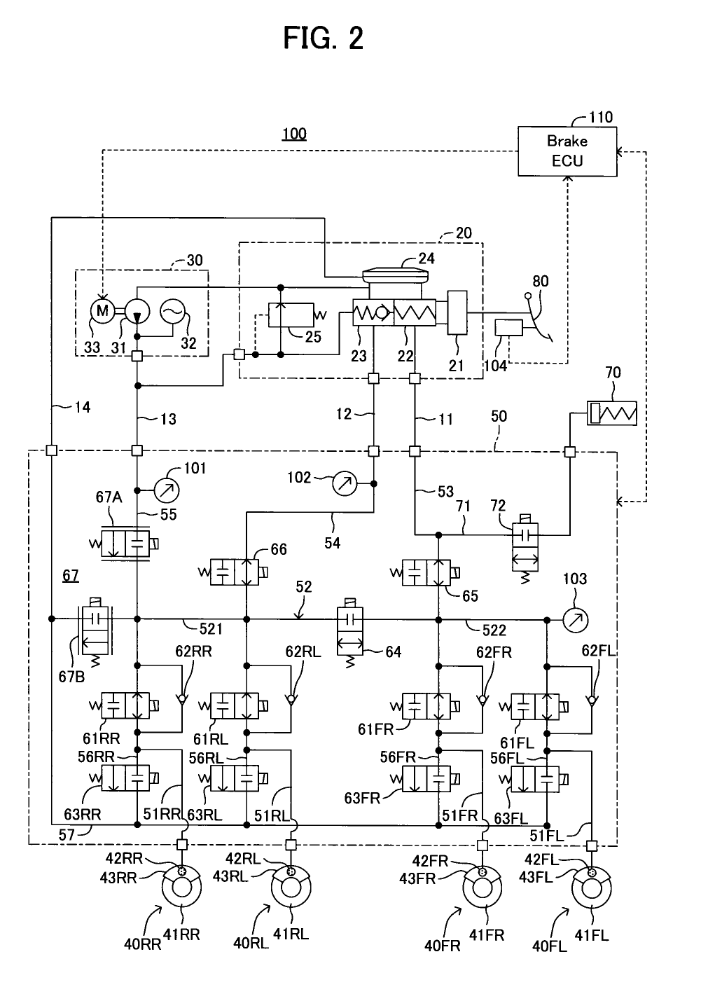

As shown in FIG. 2, the hydraulic-brake system 100 comprises the brake pedal 80, the master cylinder unit 20, the power hydraulic pressure generation device 30, the fluid pressure control valve device 50, the stroke simulator 70, the disc brake units 40FR, 40FL, 40RR and 40RL respectively disposed in each wheel, and the brake ECU110 for managing a brake regulation. In FIG. 1, the brake pedal 80, the master cylinder unit 20, the power hydraulic pressure generation device 30, the fluid pressure control valve device 50 and the stroke simulator 70 are collectively referred to and shown as the brake actuator 120. The disc brake units 40FR, 40FL, 40RR and 40RL comprise the brake disc rotors 41FR, 41FL, 41RR, 41RL and the brake calipers 43FR, 43FL, 43RR and 43RL. The brake calipers 43FR, 43FL, 43RR and 43RL are provided with wheel cylinders 42FR, 42FL, 42RR and 42RL. In addition, the configurations provided for respective wheels are denoted by suffixes FR for the front right wheel, FL for the front left wheel, RR for the rear right wheel and RL for the rear left wheel. However, in the following explanations, the suffix will be provided only when a wheel location needs to be pinpointed. In the drawings, the suffixes for pinpointing wheel locations are denoted.

The wheel cylinder 42 is connected to the fluid pressure control valve device 50, the fluid pressure of the hydraulic fluid supplied from the fluid pressure control valve device 50 is transmitted thereto, and this fluid pressure pushes the brake pad (friction member) disposed in the brake caliper 43 against the brake disc rotor 41 rotating together with the wheel W to generate a braking force for the wheel W.

The master cylinder unit 20 comprises the fluid pressure booster 21, the master cylinder 22, the regulator 23 and the reservoir 24. The fluid pressure booster 21 is connected with the brake pedal 80, amplifies the pedal pressure applied to the brake pedal 80, and transmits it to the master cylinder 22. Hydraulic fluid is supplied from the power hydraulic pressure generation device 30 to the fluid pressure booster 21 through the regulator 23 and thereby the fluid pressure booster 21 amplifies the pedal pressure and transmits it to the master cylinder 22. The master cylinder 22 generates the master cylinder pressure which has a predetermined boost ratio to pedal pressure.

The reservoir 24 which stores hydraulic fluid is disposed in the upper part of the master cylinder 22 and the regulator 23. The master cylinder 22 is communicated with the reservoir 24 when the stepping-in of the brake pedal 80 is released. The regulator 23 is communicated with both the reservoir 24 and the accumulator 32 of the power hydraulic pressure generation device 30, and generates fluid pressure almost equal to master cylinder pressure by using the accumulator 32 as the source of high pressure and the reservoir 24 as the source of low pressure. Hereafter, the fluid pressure of the regulator 23 is referred to as regulator pressure.

The power hydraulic pressure generation device 30 comprises the pump 31 and the accumulator 32. The intake of the pump 31 is connected to the reservoir 24, the outlet thereof is connected to the accumulator 32, and the pump 31 pressurizes hydraulic fluid by driving the motor 33. The accumulator 32 converts the pressure energy of the hydraulic fluid pressurized with the pump 31 into the pressure energy of sealed gas, such as nitrogen, and conserves it. Moreover, the accumulator 32 is connected to the relief valve 25 disposed in the master cylinder unit 20. When the pressure of hydraulic fluid increases unusually, the relief valve 25 is opened and returns the hydraulic fluid to the reservoir 24.

The master cylinder 22, the regulator 23 and the power hydraulic pressure generation device 30 are connected to the fluid pressure control valve device 50 through the master piping 11, the regulator piping 12 and the accumulator piping 13, respectively. Moreover, the reservoir 24 is connected to the fluid pressure control valve device 50 through the reservoir piping 14.

The fluid pressure control valve device 50 comprises the four individual passages 51 connected to each wheel cylinder 42, the main passage 52 which communicates the individual passages 51, the master passage 53 which connects the main passage 52 and the master piping 11, the regulator passage 54 which connects the main passage 52 and the regulator piping 12 and the accumulator passage 55 which connects the main passage 52 and the accumulator piping 13. The master passage 53, the regulator passage 54 and the accumulator passage 55 are connected in parallel to the main passage 52.

The ABS containment valve 61 is disposed in the middle of each individual passage 51, respectively. The ABS containment valve 61 is a normally-open electromagnetic on-off valve which will be in a closed status only during electricity is supplied to a solenoid.

Moreover, the return check valve 62 is disposed in each individual passage 51 in parallel with the ABS containment valve 61. The return check valve 62 is a valve which shuts off the flow of the hydraulic fluid going from the main passage 52 to the wheel cylinder 42 and permits the flow of the hydraulic fluid going from the wheel cylinder 42 to the main passage 52.

Moreover, the depressuring individual passage 56 is connected to each individual passage 51, respectively. Each depressuring individual passage 56 is connected to the reservoir passage 57. The reservoir passage 57 is connected to the reservoir 24 through the reservoir piping 14. The ABS pressure reducing valve 63 is disposed in the middle of each depressuring individual passage 56, respectively. Each ABS pressure reducing valve 63 is a normally-closed electromagnetic on-off valve which will be in an opened status only during electricity is supplied to a solenoid, and reduces the wheel cylinder pressure by flowing the hydraulic fluid from the wheel cylinder 42 to the reservoir passage 57 through the depressuring individual passage 56 in its opened status.

The opening and closing of the ABS containment valve 61 and the ABS pressure reducing valve 63 are controlled when the anti-lock brake regulation which prevents the lock of a wheel by reducing the wheel cylinder pressure in the event that the wheel is locked and slips, etc.

The switching valve 64 is disposed in the middle of the main passage 52. The switching valve 64 is a normally-closed electromagnetic on-off valve which will be in an opened status only during electricity is supplied to a solenoid. The main passage 52 is divided into the rear wheel side main passage 521 connected to the individual passages 51 RR and 51 RL of the rear wheels and the front wheel side main passage 522 connected to the individual passages 51FR and 51FL of the front wheels by the switching valve 64 as a boundary. The circulation of the hydraulic fluid between the rear wheel side main passage 521 and the front wheel side main passage 522 is shut off when the switching valve 64 is in a closed status, and the circulation of the hydraulic fluid between the rear wheel side main passage 521 and the front wheel side main passage 522 is permitted bidirectionally when the switching valve 64 is in an opened status.

The master cut valve 65 is disposed in the middle of the master passage 53. The master cut valve 65 is a normally-open electromagnetic on-off valve which will be in a closed status only during electricity is supplied to a solenoid. The circulation of the hydraulic fluid between the master cylinder 22 and the front wheel side main passage 522 is shut off when the master cut valve 65 is in a closed status, the circulation of the hydraulic fluid between the master cylinder 22 and the front wheel side main passage 522 is permitted bidirectionally when the master cut valve 65 is in an opened status.

In the master passage 53, the simulator passage 71 is disposed and branched on the master cylinder 22 side from the location where the master cut valve 65 is disposed. The stroke simulator 70 is connected to the simulator passage 71 through the simulator cut valve 72. The simulator cut valve 72 is a normally-closed electromagnetic on-off valve which will be in an opened status only during electricity is supplied to a solenoid. The circulation of the hydraulic fluid between the master passage 53 and the stroke simulator 70 is shut off when the simulator cut valve 72 is in a closed status, and the circulation of the hydraulic fluid between the master passage 53 and the stroke simulator 70 is permitted bidirectionally when the simulator cut valve 72 is in an opened status.

When the simulator cut valve 72 is in an opened status, while the stroke simulator 70 introduces inside the hydraulic fluid in the quantity according to the amount of brake operation and enables a stroke operation of the brake pedal 80, and the stroke simulator 70 generates the opposing force according to a pedal operation is generated and makes the brake operation feeling of a driver excellent.

The regulator cut valve 66 is disposed in the middle of the regulator passage 54. The regulator cut valve 66 is a normally-open electromagnetic on-off valve which will be in a closed status only during electricity is supplied to a solenoid. The circulation of the hydraulic fluid between the regulator 23 and the rear wheel side main passage 521 is shut off when the regulator cut valve 66 is in a closed status, and the circulation of the hydraulic fluid between the regulator 23 and the rear wheel side main passage 521 is permitted bidirectionally when the regulator cut valve 66 is in an opened status.

The accumulator passage 55 is connected to the main passage 52 (rear wheel side main passage 521) through the pressuring linear control valve 67A. The pressuring linear control valve 67A is arranged so that its upstream side is connected to the accumulator passage 55 and its downstream side is connected to the main passage 52. Moreover, the main passage 52 (rear wheel side main passage 521) is connected to the reservoir passage 57 through the depressuring linear control valve 67B. The depressuring linear control valve 67B is arranged so that its upstream side is connected to the main passage 52 and its downstream side is connected to the reservoir passage 57. The linear control valve 67 which adjusts the fluid pressure of the wheel cylinder 42 is constituted by this pressuring linear control valve 67A and this depressuring linear control valve 67B.

The pressuring linear control valve 67A and the depressuring linear control valve 67B are normally-closed electromagnetic linear control valves which maintain a closed status by the biasing force of a spring during no electricity is supplied to a solenoid and increases its opening according to the increase in the amount of electricity supplied to a solenoid (current value).

The drive control of the power hydraulic pressure generation device 30 and the fluid pressure control valve device 50 is carried out by the brake ECU110. The brake ECU110 comprises a microcomputer as its major part and further comprises a pump drive circuit, an electromagnetic valve drive circuit, an input linkage interface for inputting various kinds of sensor signals and a communication interface, etc. All of the electromagnetic on-off valves and the electromagnetic linear control valves disposed in the fluid pressure control valve device 50 are connected to the brake ECU110, and the opening-and-closing statuses and openings (in the case of the electromagnetic linear control valves) thereof are controlled by solenoid drive signals outputted from the brake ECU110. Moreover, the motor 33 disposed in the power hydraulic pressure generation device 30 is also connected to the brake ECU110 and the drive control thereof is carried out by a motor drive signal outputted from the brake ECU110.

The accumulator pressure sensor 101, the regulator pressure sensor 102 and the front wheel regulation pressure sensor 103 are disposed in the fluid pressure control valve device 50. The accumulator pressure sensor 101 detects the accumulator pressure Pacc which is the pressure of the hydraulic fluid in the accumulator passage 55 on the upstream side from the pressuring linear control valve 67A. The accumulator pressure sensor 101 outputs the signal showing the detected accumulator pressure Pacc to the brake ECU110. The regulator pressure sensor 102 detects the regulator pressure Preg which is the pressure of the hydraulic fluid in the regulator passage 54 on the upstream side (side of the regulator 23) from the regulator cut valve 66. The regulator pressure sensor 102 outputs the signal showing the detected regulator pressure Preg to the brake ECU110. The front wheel regulation pressure sensor 103 outputs the signal showing the front wheel regulation pressure Pfront which is the pressure of the hydraulic fluid in the front wheel side main passage 522 to the brake ECU110.

Moreover, the stroke sensor 104 disposed in the brake pedal 80 is connected to the brake ECU110. The stroke sensor 104 detects the pedal stroke which is the amount of stepping-in (operation) of the brake pedal 80, and outputs the signal showing the detected pedal stroke Sp to the brake ECU110. Moreover, as shown in FIG. 1, wheel-speed sensors 111FL, 111FR, 111RL, 111RR, and the acceleration sensor 112 are connected to the brake ECU110. The wheel-speed sensors 111FL, 111FR, 111RL and 111 RR are disposed respectively for wheel WFL, WFR, WRL and WRR, and output the signals showing the wheel speeds which are rotational speeds of the wheel WFL, WFR, WRL and WRR to the brake ECU110. The acceleration sensor 112 outputs the signal showing the acceleration in the front-back direction of vehicle body to the brake ECU110.

Next, the brake regulation which the brake ECU110 performs will be explained. The brake ECU110 performs brake regeneration cooperative control which makes the friction braking by the hydraulic-brake system 100 and the regenerative braking by the hybrid system 10 cooperate. In the hydraulic-brake system 100, the tread force with which the driver stepped in the brake pedal 80 is used only for detecting the amount of a brake operation, and it is not transmitted to the wheel cylinder 42, but instead, the fluid pressure which the power hydraulic pressure generation device 30 outputs is adjusted by the linear control valves 67A and 67B and transmitted to the wheel cylinder 42.

When a stepping-in operation of the brake pedal 80 is detected, the brake ECU110 changes the master cut valve 65 and the regulator cut valve 66 into a closed status, and changes the switching valve 64 and the simulator cut valve 72 into an opened status. Moreover, the ABS containment valve 61 and the ABS pressure reducing valve 63 are opened and closed according to the needs of an anti-lock brake regulation, etc., and the ABS containment valve 61 is maintained in the opened status and the ABS pressure reducing valve 63 is maintained in the closed status under normal conditions without such needs. Moreover, the brake ECU110 controls the openings of the pressuring linear control valve 67A and the depressuring linear control valve 67B to be openings according to a target fluid pressure. Thereby, the fluid pressure (accumulator pressure) which the power hydraulic pressure generation device 30 outputs is adjusted by the pressuring linear control valve 67A and the depressuring linear control valve 67B and transmitted to the wheel cylinders 42 of four wheels. In this case, since each wheel cylinder 42 is communicated with each other by the main passage 52, all the wheel cylinder pressures for the four wheels are same. This wheel cylinder pressure can be detected by the front wheel regulation pressure sensor 103.

Moreover, the brake ECU110 returns each electromagnetic valve to an initial state (status shown in FIG. 2) by stopping the supply of electricity to the fluid pressure control valve device 50, when the stepping-in operation of the brake pedal 80 is not detected.

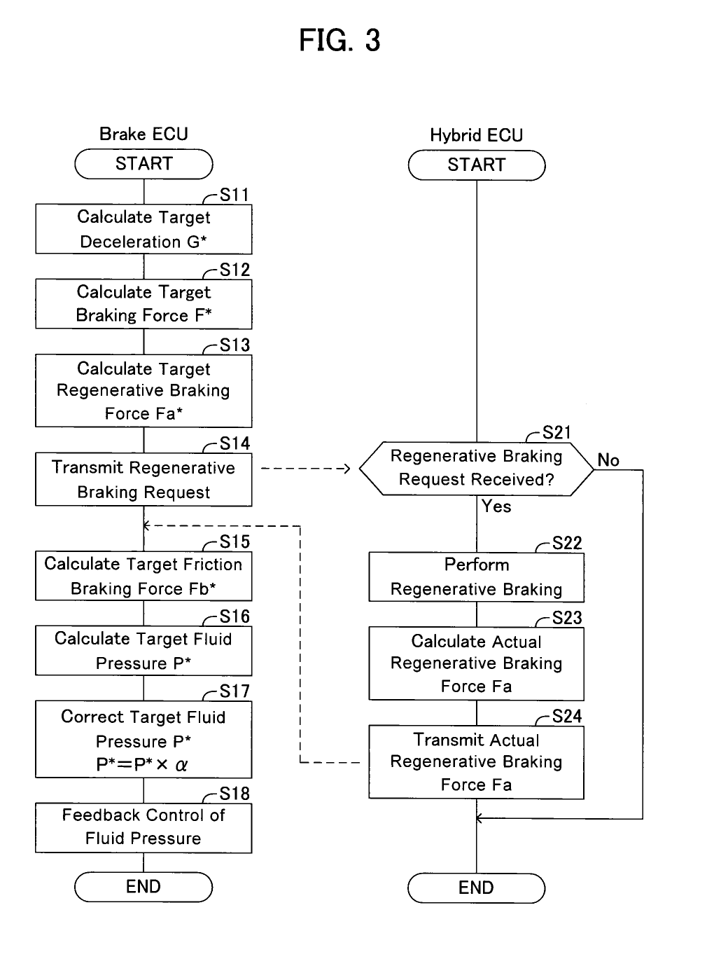

Next, the brake regeneration cooperative control will be explained. FIG. 3 is a flowchart for showing a brake regeneration cooperative control routine. The processing on the left-hand side of the drawing shows the brake regeneration cooperative control routine which the brake ECU110 performs, and the processing on the right-hand side of the drawing shows the brake regeneration cooperative control routine which the hybrid ECU8 performs. In the period during which a braking demand is being received, the brake ECU110 repeats a brake regeneration cooperative control routine at a predetermined calculation cycle. The braking demand is generated when a braking force should be given to a vehicle, for example, in a case where a driver stepped in the brake pedal 80, etc. Moreover, in the period during which the hybrid system 10 is operating, the hybrid ECU8 repeats a brake regeneration cooperative control routine at a predetermined calculation cycle.

When a braking demand is received, the brake ECU110 calculates a target deceleration G* of a vehicle body based on the pedal stroke Sp detected by the stroke sensor 104 and the regulator pressure Preg detected by the regulator pressure sensor 102 in step S11. The larger the pedal stroke Sp is and the larger the regulator pressure Preg is, the larger value the target deceleration G* is set to. The brake ECU110 has memorized a map which correlates the pedal stroke Sp with the target deceleration GS* and a map which correlates the regulator pressure Preg with the target deceleration Gp*, for example. The brake ECU110 calculates the target deceleration G* of the vehicle body by adding the value which is obtained by multiplying the target deceleration GS* computed from the pedal stroke Sp by the weighting coefficient k(0<k<1) to the value which is obtained by multiplying the target deceleration Gp* computed from the regulator pressure Preg by the weighting coefficient (1−k) (i.e. G*=k×GS*+(1−k)×Gp*). This weighting coefficient k is set to a small value in a range where the pedal stroke Sp is large.

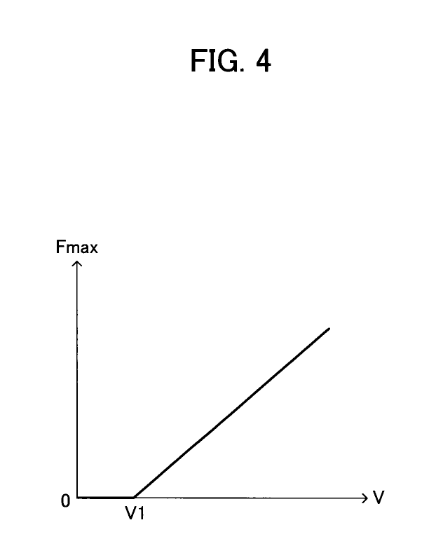

In subsequent step S12, the brake ECU110 calculates the target braking force F* of the wheel which is set up correspondingly to the target deceleration G*. Then, the brake ECU110 calculates the target regenerative braking force Fa* in step S13. In the calculation of target regenerative braking force Fa*, the brake ECU110 calculates the vehicle speed V (vehicle body speed) based on the wheel speeds detected by wheel speed sensors 111FL, 111FR, 111RL and 111RR, and calculates the maximum regenerative braking force Fmax corresponding to the speed V with reference to the maximum regenerative braking force map. As shown in FIG. 4, the maximum regenerative braking force map has the property that it sets the maximum regenerative braking force Fmax to zero when the vehicle speed V is less than V1 and sets the maximum regenerative braking force Fmax to a larger value according as the vehicle speed V is larger when the vehicle speed V is V1 or more. The brake ECU110 sets smaller one of the target braking force F* and the maximum regenerative braking force Fmax as target regenerative braking force Fa*. Therefore, the target regenerative braking force Fa* will be set to the value of the target braking force F* as it is when the target braking force F* is smaller than the maximum regenerative braking force Fmax, and the regenerative braking force Fa* will be set to the value of the maximum regenerative braking force Fmax when the target braking force F* is larger than the maximum regenerative braking force Fmax.

Then, the brake ECU110 transmits a regenerative braking request command to the hybrid ECU8 in step S14. The information showing the target regenerative braking force Fa* is included in this regenerative braking request command. In step S21, the hybrid ECU8 repeatedly judges at a predetermined cycle about whether the regenerative braking request command was transmitted from the brake ECU110 or not. And, when the regenerative braking request command is received, it operates the motor 2 as a generator so that the regenerative braking force as close to the target regenerative braking force Fa* as possible is generated, while setting the target regenerative braking force Fa* as an upper limit, in step 22. The electric power generated by the motor 2 is regenerated in the battery 1 through the inverter 6. In this case, the hybrid ECU8 controls the switching chip of the inverter 6 so that the power-generation current flowing in the motor 2 follows the current corresponding to the target regenerative braking force Fa*. In step S23, the hybrid ECU8 calculates the actual regenerative braking force (referred to as the actual regenerative braking force Fa) generated by the motor 2 based on the power-generation current and power-generation voltage of the motor 2, and transmits the information showing the actual regenerative braking force Fa to the brake ECU110 in subsequent step S24. The hybrid ECU8 will once end this routine when the processing in step S24 has been completed. And, the above-mentioned processing will be repeated at a predetermined calculation cycle.

When the information showing the actual regenerative braking force Fa transmitted from the hybrid ECU8 is received, the brake ECU110 calculates the target friction braking force Fb* (=F*−Fa) by subtracting the actual regenerative braking force Fa from the target braking force F*, in step S15. And in step S16, it calculates the common target fluid pressure P* of the wheel cylinder 42 for four wheels, which is set up corresponding to this target friction braking force Fb*. The fluid pressure of the wheel cylinder 42 for four wheels is controlled commonly by the pressuring linear control valve 67A and the depressuring linear control valve 67B. Therefore, the target fluid pressure P* of the wheel cylinder 42 for four wheels becomes a common value.

Then, the brake ECU110 corrects the target fluid pressure P* by the deceleration ratio α in step S17. This deceleration ratio α is a value computed by the deceleration ratio calculation routine which will be mentioned later, and is equivalent to a correction coefficient. The brake ECU110 sets a value which is obtained by multiplying the target fluid pressure P* by the deceleration ratio α as a new target fluid pressure P*(P*=P*×α).

Then, in step S18, the brake ECU110 controls the drive currents of the pressuring linear control valve 67A and the depressuring linear control valve 67B by a feedback control so that the wheel cylinder pressure becomes equal to the target fluid pressure P*. Namely, it controls the current sent through each of the solenoids of the pressuring linear control valve 67A and the depressuring linear control valve 67B so that the front wheel regulation pressure Pfront (=wheel cylinder pressure) detected by the front wheel regulation pressure sensor 103 follows the target fluid pressure P*. The brake ECU110 will once end this routine when the processing in step S18 is performed. And the above-mentioned processing will be repeated at a predetermined cycle.

Thus, the brake control device according to the present embodiment decelerates a vehicle at the target deceleration G* by making the front wheels WFL and WFR generate regenerative braking force and friction braking force and making the rear wheels WRL and WRR generate friction braking force. In this case, since the target regenerative braking force Fa* is set as the value of the smaller one among the target braking force F* and the maximum regenerative braking force Fmax, only the regenerative braking force resulting from a power generation by the motor 2 is given to the front wheels WFL and WFR when the target braking force F* is small. Moreover, when the target braking force F* is large and the target braking force F* cannot be generated only by the regenerative braking force, the friction braking force of an extent to compensate the shortfall of the braking force is given to all the wheels W by the disc brake units 40. Moreover, since the target regenerative braking force Fa* is set as zero when the vehicle speed V is less than V1, only the friction braking force by the disc brake units 40 is given to all the wheels W.

Thus, during the brake regeneration cooperative control, in order to set up the target friction braking force Fb* by subtracting the actual regenerative braking force Fa from the target braking force F*(=F*−Fa), there are a braking mode in which the target braking force F* is generated only by the regenerative braking force, another braking mode in which the target braking force F* is generated by the regenerative braking force and the friction braking force, and further another braking mode in which the target braking force F* in generated only by the friction braking force, and the braking mode is switched among these braking modes. The braking mode in which the target braking force F* is generated only by the regenerative braking force is referred to as the regenerative braking mode, the braking mode in which the target braking force F* in generated by the regenerative braking force and the friction braking force is referred to as the cooperative braking mode, and the braking mode in which the target braking force F* is generated only by the friction braking force is referred to as the friction braking mode. During the brake regeneration cooperative control, in order to effectively use the regenerative braking force, the regenerative braking mode is more preferentially set up as compared with other braking modes.

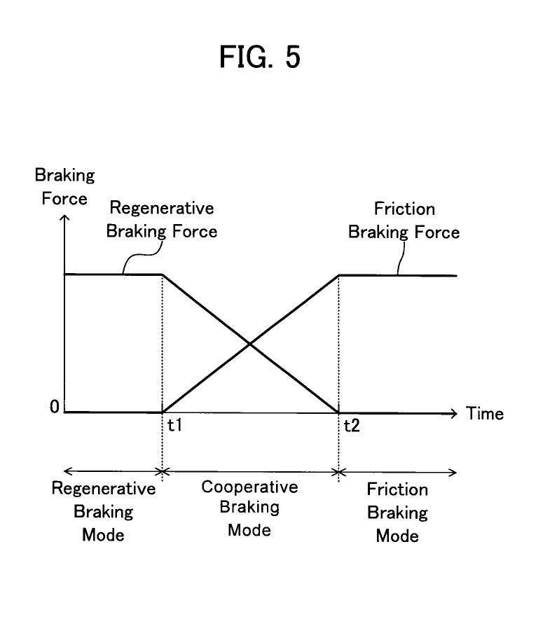

Next, the deceleration ratio used in order to correct the target fluid pressure P* will be explained. When the above-mentioned brake regeneration cooperative control is carried out, the braking mode may be switched while the driver is stepping on the brake pedal. For instance, given that a driver is stepping on a brake pedal and the vehicle speed is falling, since large regenerative braking force is acquired (the maximum regenerative braking force Fmax is large) during the period when the vehicle speed is high, the braking regulation in accordance with the regenerative braking mode is carried out. When the vehicle speed comes to decline from such a status, the maximum regenerative braking force Fmax becomes smaller in association with it, it becomes impossible to generate the target braking force F* only by the regenerative braking force. Thereby, the braking mode shifts from the regenerative braking mode to the cooperative braking mode. FIG. 5 is a graph for showing the transitions of the regenerative braking force and the friction braking force when the driver is giving constant brake operation force and the vehicle is slowing down. As shown, at the time t1 or before, the braking regulation by the regenerative braking mode is carried out. And, in association with the reduction of the vehicle speed, the regenerative braking force decreases from the time t1, and the friction braking force is applied so that the decrement is compensated. Thus, the braking mode shifts from the regenerative braking mode to the cooperative braking mode. And at the time t2, the regenerative braking force becomes zero and only the friction braking force is given to a wheel. Therefore, the braking mode shifts from the regenerative braking mode to the friction braking mode through the cooperative braking mode. In addition, in the following explanation, the time t1 is designated as the timing at which the braking mode shifts from the regenerative braking mode to cooperative braking mode, and the time t2 is designated as the timing at which the braking mode shifts from the cooperative braking mode to regenerative braking mode.

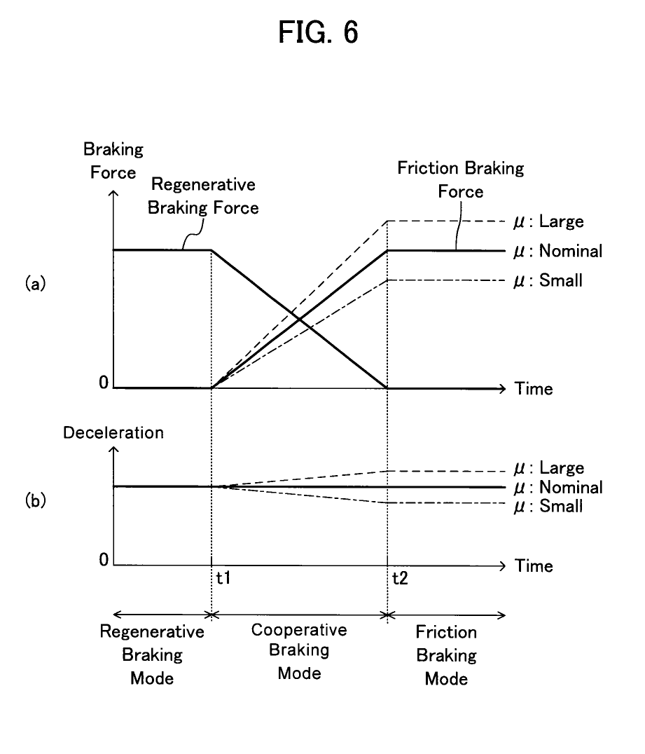

The friction coefficient of the friction member (a brake rotor disk and a brake pad) which generates friction braking force changes with aging, temperature, humidity, etc. For this reason, when the friction coefficient μ is larger as compared with a design assumption value (hereafter, a design assumption value is referred to as a nominal value), the friction braking force becomes larger as compared with the nominal value, as shown with a dashed line in FIG. 6 (a), and the deceleration of the vehicle body becomes larger as compared with the nominal value, as shown with a dashed line in FIG. 6 (b). On the contrary, when the friction coefficient μ is smaller as compared with the nominal value, the friction braking force becomes smaller as compared with the nominal value, as shown with an alternate long and short dash line in FIG. 6 (a), and the deceleration of the vehicle body becomes smaller as compared with the nominal value, as shown with an alternate long and short dash line in FIG. 6 (b).

Therefore, even when the driver operates a brake pedal with constant force, the deceleration of the vehicle body will be changed with a transition of the braking mode. Then, in the present embodiment, on the basis of the actual deceleration A of the vehicle body during the execution of the regenerative braking mode which is not influenced by the change of the friction coefficient μ, a ratio of the actual deceleration B of the vehicle body during the execution of the friction braking mode with the same required braking force as that during the execution of the regenerative braking mode to this actual deceleration A is calculated as the deceleration ratio α. Although the deceleration ratio α is computed as A/B in order to use the deceleration ratio α as a correction coefficient in the present embodiment, it may be computed as B/A.

This deceleration ratio α is equivalent to the gap index according to the present invention, i.e. the gap index which shows a gap of a correlation between a required braking force and an actually obtained deceleration of the vehicle body at the time of an execution of the friction braking mode from a basis which is a correlation between a required braking force and an actually obtained deceleration of the vehicle body at the time of an execution of the regenerative braking mode. The gap index shows that the further the deceleration ratio α separates from the value 1, the larger the above-mentioned gap is.

### <First Embodiment According to Deceleration Ratio Calculation>

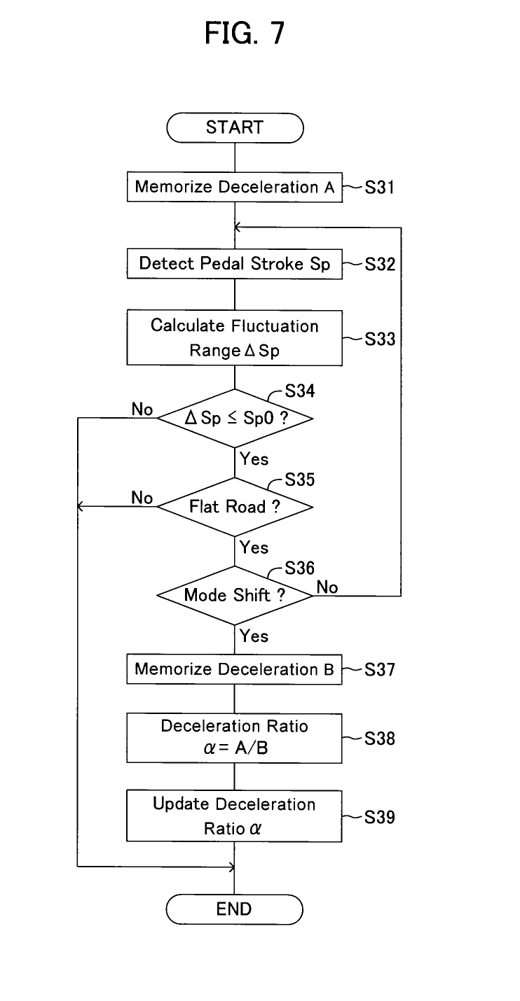

Next, the processing for detecting the deceleration ratio α will be explained. FIG. 7 is a flowchart for showing the deceleration ratio calculation routine which the brake ECU110 performs. This deceleration ratio calculation routine is started each time when the braking mode shifts from the regenerative braking mode to the cooperative braking mode (for instance, at the time t1 in FIG. 5), and is performed in parallel to the brake regeneration cooperative control routine. When the deceleration ratio calculation routine starts, the brake ECU110 calculates and memorizes the deceleration A when the braking mode shifts from the regenerative braking mode to the cooperative braking mode in step S31. The brake ECU110 computes the vehicle speed V (vehicle body speed) based on the wheel speeds of the four wheels detected by the wheel speed sensors 111, and calculates the deceleration A of the vehicle body by differentiating this vehicle speed V with respect to time. Alternatively, the deceleration A is calculated based on the detection value detected by the acceleration sensor 112. Thereby, the deceleration A at the time t1 shown in FIG. 5 is detected, for example. In addition, this deceleration A is substantially equal to the deceleration in the regenerative braking mode just before shifting to the cooperative braking mode.

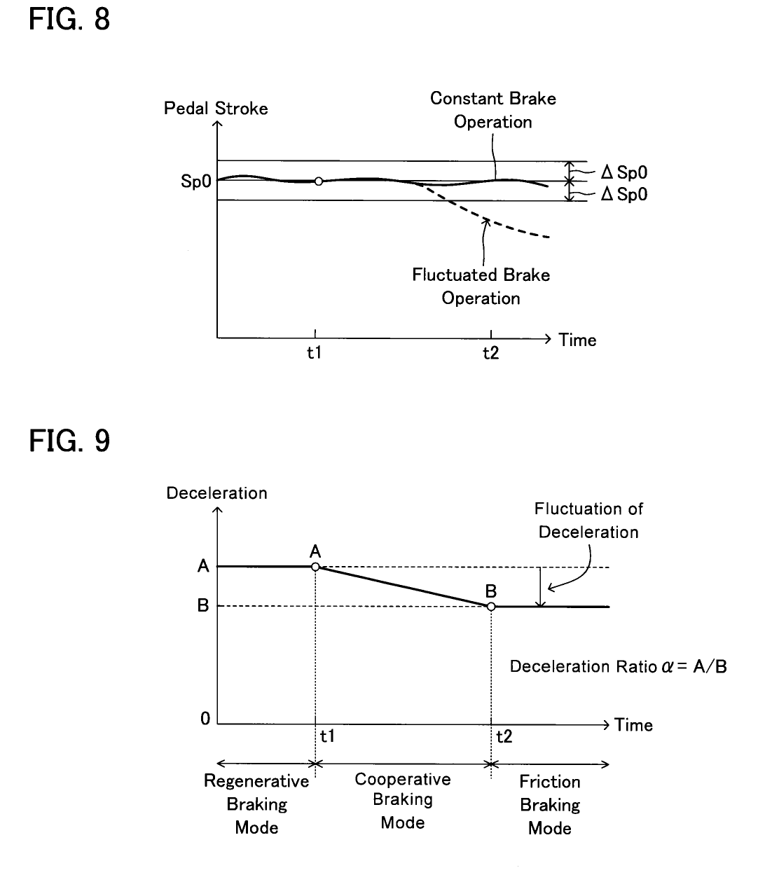

Then, the brake ECU110 detects the pedal stroke Sp which is the amount of stepping-in (operation amount) of the brake pedal 80 detected by the stroke sensor 104 in step S32. Then, in step S33, the fluctuation range ΔSp of the pedal stroke Sp is calculated. As shown in FIG. 8, this fluctuation range ΔSp is calculated as the deviation ΔSp from a standard value Sp0 which is the pedal stroke Sp at the time of the start-up of the deceleration ratio calculation routine (=|Sp−Sp0|). Since the detection value of the pedal stroke Sp is set as the standard value Sp0 when this step S32 is performed for the first time, the fluctuation range ΔSp is set to zero.

Then, the brake ECU110 judges whether the fluctuation range ΔSp is mot more than a predetermined threshold value ΔSp0, in step S34. This threshold value ΔSp0 is a threshold value for judging whether the brake operation is performed at a constant operation amount or not. That is, it is a threshold value for judging whether the amount of brake operations is in an extent which does not change the deceleration of the vehicle body or not. When the fluctuation range ΔSp is judged to be the predetermined threshold value ΔSp or less, the brake ECU110 judges whether the vehicle is running on a flat road, in subsequent step S35. This judgment may be done using a well-known ramp detection technique, or may be done based on the current location information of the vehicle obtained from GPS and the ramp information included in a navigation map information, for example.

When it is judged that the vehicle is running on a flat road, the brake ECU110 judges whether the braking mode has shifted from the cooperative braking mode to friction braking mode, in subsequent step S36. The brake ECU110 returns the processing to step S32, when the cooperative braking mode is being performed. In this way, the pedal stroke Sp in the cooperative braking mode is detected, the brake ECU110 repeatedly judges whether the brake operation is performed with a constant operation amount from this detection value (S33, S34), whether the vehicle is running on a flat road (S35), and whether the braking mode has shifted to the friction braking mode (S36).

Such processing is repeated and the brake ECU110 calculates and memorizes the deceleration B in step S37 when the braking mode shifts to the friction braking mode. This deceleration B shows the deceleration of the vehicle body at the timing (for instance, time t2 shown in FIG. 5) at which the braking mode shifted to the friction braking mode. Then, the brake ECU110 computes the deceleration ratio α by dividing the deceleration A by the deceleration B in step S38 (α=A/B). And, in step S39, the memorized deceleration ratio α is updated to the deceleration ratio α computed in this step S38. This updated deceleration ratio α is used in step S17 included in the above-mentioned brake regeneration cooperative control routine, and serves as a correction coefficient for correcting the target fluid pressure P*.

When the processing in step S39 is performed, the brake ECU110 ends the deceleration ratio calculation routine. The brake ECU110 performs the deceleration ratio operation routine each time when the braking mode shifts from the regenerative braking mode to the cooperative braking mode. Thereby, the deceleration ratio α comes to be learned. The brake ECU110 has memorized the initial value of the deceleration ratio α (for instance, α=1), and updates the deceleration ratio α from this initial value.

Moreover, the brake ECU110 ends the deceleration ratio calculation routine, when it is judged that the brake operation is not performed at a constant operation amount in step S34 (S34: No), or when it is judged that the vehicle is running on a ramp. In this case, the deceleration ratio α is not updated.

When the driver performs a brake operation at a constant operation amount (a fixed amount of brake pedal stepping-in), the deceleration of a vehicle body is desired to become constant. Moreover, the brake control device is designed accordingly. However, when the friction coefficient of the friction member which generates the friction braking force changes, the relations between the required braking force and the deceleration of the vehicle body in the friction braking mode and cooperative braking mode change. On the other hand, in the regenerative braking mode, since the friction member is not used, there is not such a thing. For this reason, even if the driver is performing a constant brake operation, when shifting from the regenerative braking mode to the friction braking mode through the cooperative braking mode, the deceleration of a vehicle body may be changed and sense of discomfort may be given to the driver.

Then, as shown in FIG. 9, the brake ECU110 detects, as the deceleration ratio α, the fluctuation of the deceleration of the vehicle body when the braking mode shifts from the regenerative braking mode to the friction braking mode through the cooperative braking mode in the status that the brake operation is being retained constant. In the regenerative braking mode, the relation between the required braking force and the deceleration of the vehicle body is not influenced by the friction coefficient of the friction member. For this reason, the brake ECU110 computes, as the deceleration ratio α, the gap of a correlation between the required braking force and the actually obtained deceleration of the vehicle body at the time of the execution of the friction braking mode from a basis which is a correlation between the required braking force and the actually obtained deceleration of the vehicle body at the time of the execution of the regenerative braking mode, and corrects the target braking force * using this deceleration ratio α. In the present embodiment, since the deceleration ratio α is used as a correction coefficient for correcting the target fluid pressure P*, the deceleration ratio α is set as A/B.

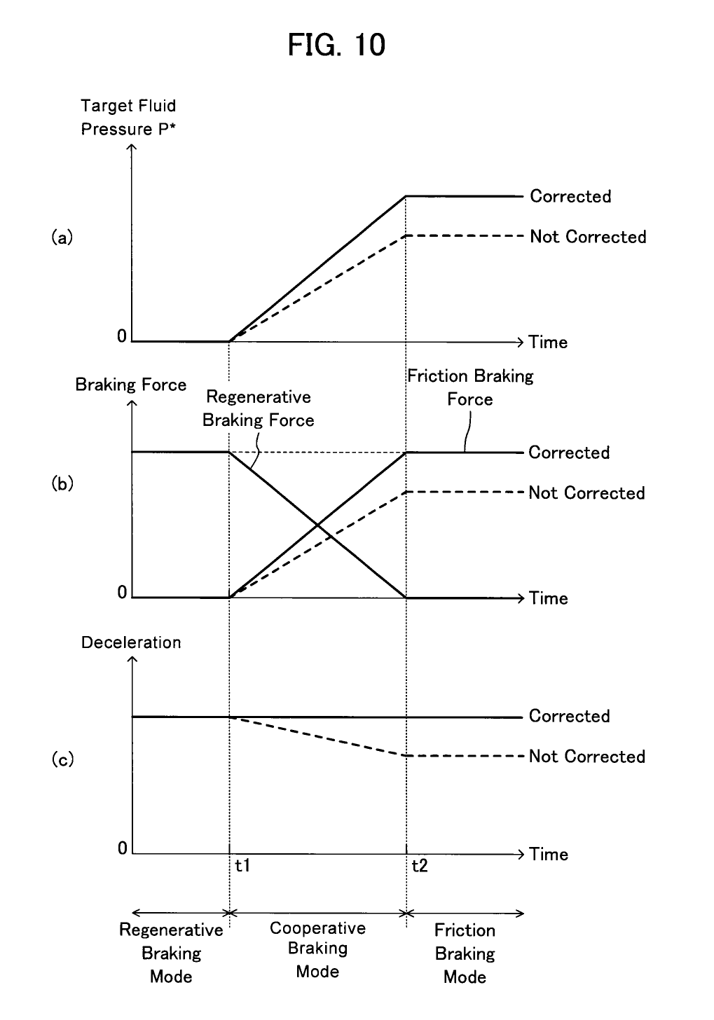

The brake ECU110 corrects the target fluid pressure P* using this deceleration ratio α in step S17 included in the brake regeneration cooperative control routine. For instance, when the deceleration at the time of the execution of the friction braking mode becomes smaller as compared with the deceleration at the time of the execution of the regenerative braking mode, the deceleration ratio α larger than a value “1” is set up. For this reason, as shown in FIG. 10 (a), the target fluid pressure P*(=P*×α) is corrected to be increased. Therefore, when a constant brake operation is performed, as shown in FIG. 10 (b), the friction braking force at the time of shifting to the friction braking mode becomes the same extent as the regenerative braking force in the regenerative braking mode. As a result, the deceleration of the vehicle body becomes not fluctuated as shown in FIG. 10 (c), and sense of discomfort can be prevented from being given to the driver. In addition, the dashed line in FIG. 10 shows a comparative example in which the target fluid pressure P* is not corrected by the deceleration ratio α.

Although the friction coefficient of a friction member changes largely in accordance with weather and temperature, since the deceleration ratio calculation routine starts each time when shifting from the regenerative braking mode to the cooperative braking mode in the present embodiment, the deceleration ratio α will be learned so as to follow the change of the friction coefficient of the friction member. For this reason, the deceleration of the vehicle body becomes always proper. In addition, the deceleration ratio calculation routine does not necessarily need to be carried out each time when shifting from the regenerative braking mode to the cooperative braking mode, and it may be carried out when a predetermined condition is satisfied, for instance, once in every predetermined number of occasions.

Moreover, the relation between the required braking force and the deceleration of the vehicle body changes also depending on the vehicle weight. It is the same regardless of whether the braking mode is the regenerative braking mode or the friction braking mode. When the braking mode shifts from the regenerative braking mode to the friction braking mode through the cooperative braking mode, the vehicle weight does not change. For this reason, in the brake control device according to the present embodiment, when braking mode shifts as mentioned above, the deceleration of the vehicle body does not change. On the other hand, in the brake control device disclosed in Patent Document 1 (PTL1) quoted as a prior art device, since the control amount of friction braking is corrected based on the difference between a design deceleration on a specific vehicle weight condition and an actual deceleration, the deceleration of a vehicle body will change at the time of a transition of braking mode when the vehicle weight differs from its assumed value on design, even if a brake operation is constant. Therefore, the brake control device according to the present embodiment can suppress the change of the deceleration of the vehicle body at the time of the transition of braking mode as compared with the prior art device.

In addition, although the deceleration A immediately after the braking mode shifts from the regenerative braking mode to the cooperative braking mode is memorized as a deceleration at the time of the execution of the regenerative braking mode in the present embodiment, the deceleration A before shifting to the cooperative braking mode may be memorized as long as the brake operation has been being performed at a constant operation amount since a time point before shifting to the cooperative braking mode, for instance. Moreover, although the deceleration B immediately after the braking mode shifts from the cooperative braking mode to the friction braking mode is memorized as a deceleration at the time of the execution of the friction braking mode in the present embodiment, the deceleration B further after, i.e. not immediately after, shifting to the friction braking mode may be memorized as long as the brake operation has been being performed at a constant operation amount after shifting to the friction braking mode, for instance.

Moreover, although it is judged whether the brake operation is retained constant based on the fluctuation width of the pedal stroke Sp detected by the stroke sensor 104 in the present embodiment, it can be judged based on the fluctuation width of the brake operation force (stepping-in force of the brake pedal 80) by a driver. In that case, the fluctuation width of the regulator pressure Preg may be detected by the regulator pressure sensor 102. Moreover, it may be judged whether the brake operation is retained constant based on the fluctuation width of the control amount corresponding to the control amount of the brake (for instance, the target braking force F*, the target deceleration G*, etc.).

### <Second Embodiment According to Deceleration Ratio Calculation>

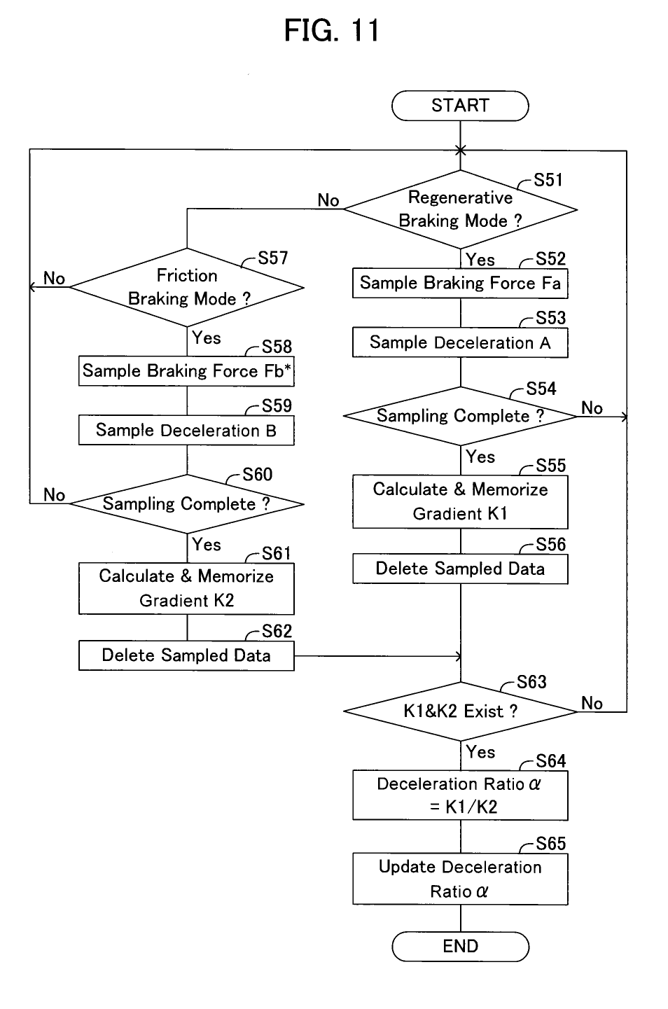

Next, the deceleration ratio calculation processing according to the second embodiment will be explained. FIG. 11 is a flowchart for showing the deceleration ratio calculation routine according to the second embodiment that the brake ECU110 performs. During braking, this deceleration ratio calculation routine is performed repeatedly. When the deceleration ratio calculation routine starts, the brake ECU110 judges whether the braking mode at present is the regenerative braking mode or not in step S51. When it is the regenerative braking mode (S51: Yes), the brake ECU110 reads and memorizes the newest actual regenerative braking force Fa (actual regenerative braking force at present) transmitted from the hybrid ECU8 in step S52. Then, the brake ECU110 calculates and memorizes the deceleration A of the vehicle body by differentiating the vehicle speed with respect to time in step S53. In this way, the data (Fa, A) showing a pair of the actual regenerative braking force Fa and the deceleration A at the time of the execution of the regenerative braking mode is sampled.

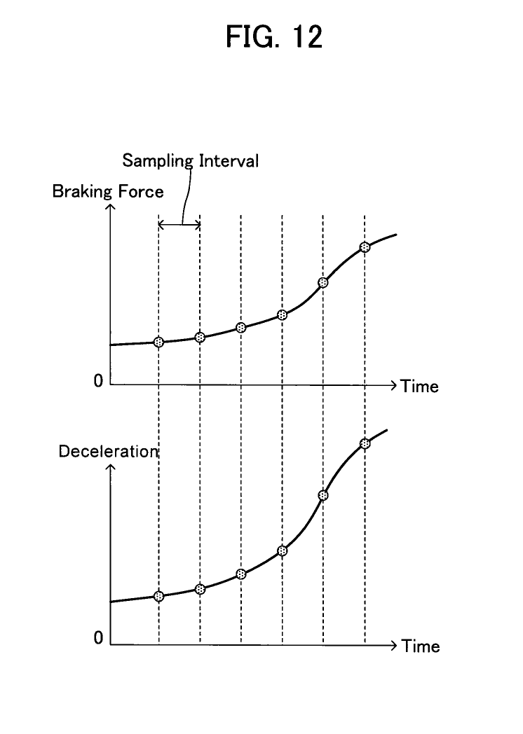

Then, the brake ECU110 judges whether the completion condition of the sampling of the data (Fa, A) showing the actual regenerative braking force Fa and the deceleration A is satisfied or not in step S54. The brake ECU110 has previously memorized the completion condition of the sampling of the data (Fa, A) showing the actual regenerative braking force Fa and the deceleration A. For instance, the brake ECU110 has memorized, as the completion condition of the sampling, a fact that the number of the sampling of data (Fa, A) is equal to or more than a predetermined number and a sampling width (Famax−Famin) which is a difference between the maximum value (Famax) and the minimum value (Famin) of the sampled actual regenerative braking force Fa is equal to or more than a predetermined value. The brake ECU110 returns the processing to step S51, while the completion condition of the sampling of data (Fa, A) is not fulfilled. FIG. 12 contains graphs for showing a situation where the data showing the actual regenerative braking force Fa and the deceleration A are sampled at a predetermined cycle.

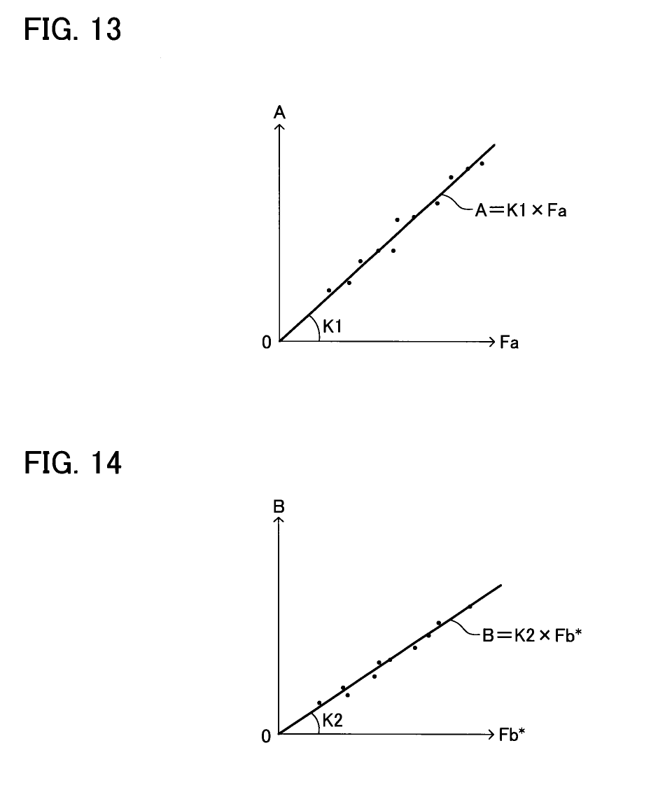

The brake ECU110 repeats such processing, and calculates a gradient K1 of a linear function showing the relation between the actual regenerative braking force Fa and the deceleration A in step S55 when the completion condition of the sampling of data (Fa, A) is satisfied. For instance, as shown in FIG. 13, when the above-mentioned sampled data (Fa, A) is plotted to a plane coordinate with the actual regenerative braking force Fa as the horizontal axis and the deceleration A as the vertical axis, the relation between the actual regenerative braking force Fa and the deceleration A is shown by a linear function (A=K1×Fa). In step S55, the brake ECU110 presumes this linear function from the distribution of the sampled data (Fa, A), and calculates and memorizes its gradient K1. Since the target braking force F* is generated only by the regenerative braking force at the time of the execution of the regenerative braking mode, the relation between the actual regenerative braking force Fa and the deceleration A means the relation between the required braking force (target braking force F*) and the deceleration A. Therefore, this linear function is equivalent to the regeneration deceleration property in the present invention. Then, the brake ECU110 deletes the sampled data (Fa, A) in step S56.

On the other hand, when it is judged that the braking mode at present is not the regenerative braking mode in step S51, the brake ECU110 judges whether the braking mode at present is the friction braking mode or not in step S57. The brake ECU110 returns the processing to step S51 when it is judged that it is not the friction braking mode, and proceeds with the processing to step S58 when it is judged that it is the friction braking mode. In step S58, the brake ECU110 reads and memorizes the target friction braking force Fb* at present, and calculates and memorizes the deceleration B of the vehicle body by differentiating the vehicle speed with respect to time in subsequent step S59. In this way, the data (Fb*, B) showing a pair of the target friction braking force Fb* and the deceleration B at the time of the execution of the friction braking mode is sampled.

Then, the brake ECU110 judges whether the completion condition of the sampling of the data (Fb*, B) showing the target friction braking force Fb* and the deceleration B is satisfied or not in step S60. The brake ECU110 has previously memorized the completion condition of the sampling of the data (Fb*, B) showing the target friction braking force Fb* and the deceleration B. For instance, the brake ECU110 has memorized, as the completion condition of the sampling, a fact that the number of the sampling of data (Fb*, B) is equal to or more than a predetermined number and a sampling width (Fb*max−Fb*min) which is a difference between the maximum value (Fb*max) and the minimum value (Fb*min) of the target friction braking force Fb* is equal to or more than a predetermined value. The brake ECU110 returns the processing to step S51, while the completion condition of the sampling of data (Fb*, B) is not fulfilled. Similarly to the sampling of data (Fa, A) (FIG. 12), the data (Fb*, B) is sampled at a predetermined cycle.

The brake ECU110 repeats such processing, and calculates a gradient K2 of a linear function showing the relation between the target friction braking force Fb* and the deceleration B in step S61 when the completion condition of the sampling of data (Fb*, B) is satisfied. For instance, as shown in FIG. 14, when the above-mentioned sampled data (Fb*, B) is plotted to a plane coordinate with the target friction braking force Fb* as the horizontal axis and the deceleration B as the vertical axis, the relation between the target friction braking force Fb* and the deceleration B is shown by a linear function (B=K2×Fb*). In addition, FIG. 14 is a graph for showing a case where the friction coefficient μ of the friction member is smaller than a nominal value. In step S61, the brake ECU110 presumes this linear function from the distribution of the sampled data (Fb*, B), and calculates and memorizes its gradient K2. Since the target braking force F* is generated only by the friction braking force at the time of the execution of the friction braking mode, the relation between the target friction braking force Fb* and the deceleration B means the relation between the required braking force (target braking force F*) and the deceleration B. Therefore, this linear function is equivalent to the friction deceleration property in the present invention. Then, the brake ECU110 deletes the sampled data (Fb*, B) in step S62.

When the processing in step S56 or step S62 is completed, the brake ECU110 proceeds with the processing to step S63, and judges whether both the gradient K1 and the gradient K2 have been memorized or not. The brake ECU110 returns the processing to step S51 when it judges as “No”, while it proceeds with the processing to step S64 when it judges as “Yes” and computes the deceleration ratio α by dividing the gradient K1 by the gradient K2 (α=K1/K2). Then, in step S65, the memorized deceleration ratio α is updated to the deceleration ratio α computed in this step S64. This updated deceleration ratio α is used in step S17 of the above-mentioned brake regeneration cooperative control routine, and serves as a correction coefficient for correcting the target fluid pressure P*.

The brake ECU110 carries out the deceleration ratio calculation routine at a predetermined cycle. Thereby, similarly to the first embodiment, the deceleration ratio α is learned so as to follow the change of the friction coefficient of the friction member. In addition, since the gradient K1 showing the relation between the regenerative braking force and the deceleration in the regenerative braking mode is constant when the vehicle weight does not change, the update frequency of memory can be lessened. For instance, after memorizing gradient K1 in step S55, the processing from step S52 to step S56 may be skipped until a condition under which the vehicle weight may change is detected (for instance, an opening-and-closing of a door is detected, an ignition switch is detected to be turned off, etc.).

### <Resetting Learning Value of Deceleration Ratio α>

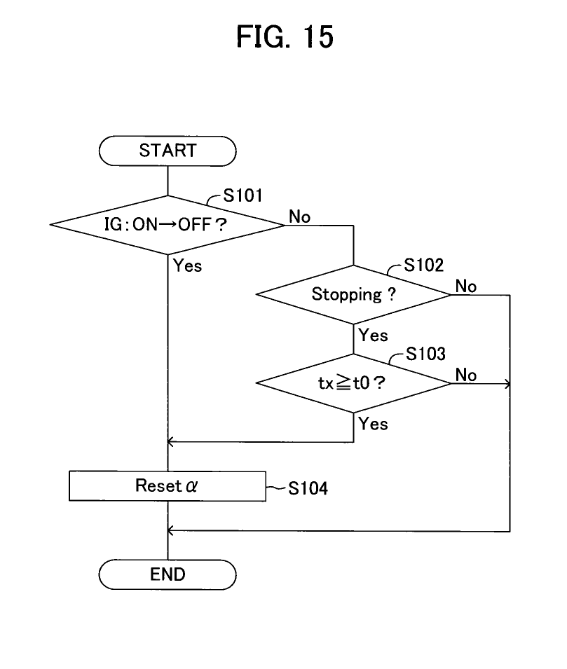

The friction coefficient of a friction member largely changes with the weather or temperature. For this reason, when the period during which a vehicle is stopping is long, the friction coefficient may change during the period and the learning value (update value) of the deceleration ratio α may not become suitable. Then, the brake ECU110 carries out a learning value reset processing. FIG. 15 is a flowchart for showing a learning value reset routine which the brake ECU110 carries out. This learning value reset routine is repeatedly carried out by the brake ECU110 at a predetermined cycle. Moreover, this learning value reset routine can be combined with and applied to either the first or second embodiment of the deceleration ratio calculation routine.

The brake ECU110 judges whether the ignition switch (not shown) has been changed from the ON state to the OFF state in step S101. When it is not the timing when the ignition switch is changed from the ON state to the OFF state (S101: No), the brake ECU110 judges whether the vehicle has been stopped or not in step S102, and the brake ECU110 judges whether the stop duration tx has become more than a threshold value t0 or not in step S103 when the vehicle has been stopped. The brake ECU110 once ends the learning value reset routine, when vehicles has not been stopped (S102: No), or when the stop duration tx is less than the threshold value t0 even though it has been stopped (S103: No).

The brake ECU110 repeats such processing, and resets the deceleration ratio α to an initial value in step S104, when the ignition switch is changed from an ON state to an OFF state (S101: Yes), or when the stop duration tx becomes more than threshold value t0 (S103: Yes). That is, the learned deceleration ratio α is returned to a predetermined initial value (for instance, α=1). Thereby, since the deceleration ratio α is returned to the initial value in a situation where there is a possibility that the friction coefficient of the friction member may change, the deceleration which has become less proper can be prevented from being used.

In accordance with the brake control device according to the present embodiment explained above, since the target fluid pressure P* is corrected using the deceleration ratio α, the fluctuation of the deceleration of the vehicle body produced when shifting from the regenerative braking mode to the friction braking mode through the cooperative braking mode can be suppressed. This deceleration ratio α shows the extent of the gap of the correlation between the required braking force and the actually obtained deceleration of the vehicle body at the time of the execution of the friction braking mode from the basis which is the correlation between the required braking force and the actually obtained deceleration of the vehicle body at the time of the execution of the regenerative braking mode. For this reason, regardless of the change of the vehicle weight, the target fluid pressure P* can be always corrected using the proper deceleration ratio α. In a prior art device, since the correction coefficient is computed from the ratio of a reference deceleration set up on a specific vehicle weight condition and an actual deceleration, a proper correction coefficient cannot be obtained when the actual vehicle weight is different from an assumed vehicle weight. On the contrary, in the brake control device according to the present embodiment, focusing attention to the fact that the correlation between the required braking force and the deceleration of the vehicle body at the time of the execution of the regenerative braking mode does not depend on the friction coefficient of the friction member and the fact that the vehicle weight condition when shifting from the regenerative braking mode to the friction braking mode does not change, and the correlation between the required braking force and the actually obtained deceleration of the vehicle body at the time of the execution of the regenerative braking mode is used as a basis. Therefore, the target fluid pressure P* can be properly corrected regardless of the change of the vehicle weight.

Moreover, in the present embodiment, since the target fluid pressure P* is corrected using the deceleration a which shows the ratio of the deceleration A acquired at the time of the execution of the regenerative braking mode and the deceleration B acquired at the time of the execution of the friction braking mode under a common required braking force condition, the target fluid pressure P* can be corrected properly and easily. Moreover, in accordance with the deceleration ratio calculation routine according to the first embodiment, since the deceleration ratio α is calculated at the time of a series of brake operations during which the operation amount has been retained constant, a proper deceleration ratio α can be acquired. Moreover, in accordance with the deceleration ratio operation routine according to the second embodiment, since the deceleration ratio α is calculated using the sampling data (Fa, A) at the time of the execution of the regenerative braking mode and the sampling data (Fb*, B) at the time of the execution of the friction braking mode, the deceleration ratio α can be easily acquired without requiring a constant brake operation.

<Modification of Brake Regeneration Cooperative Control Routine>

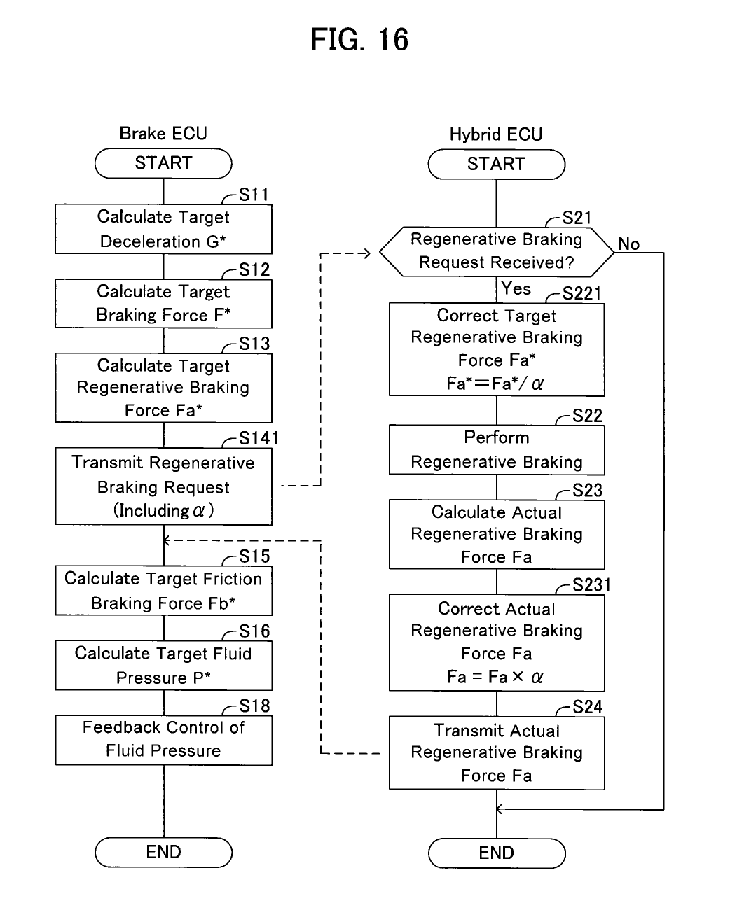

Although the target fluid pressure P* is corrected using the deceleration ratio α in the above-mentioned embodiments, the regenerative braking force can be also corrected alternatively. FIG. 16 is a flowchart for showing a modification of a brake regeneration cooperative control routine. As for the processing common to the brake regeneration cooperative control routine shown in FIG. 2, the same step numbers as those in FIG. 2 are given in FIG. 16 and the explanations thereof are omitted. The brake ECU110 transmits the regenerative braking request command including the information showing the deceleration ratio α to the hybrid ECU8 in step S141. When the hybrid ECU8 receives the regenerative braking request command from the brake ECU110 in step S21, the hybrid ECU8 divides the target regenerative braking force Fa* contained in the regenerative braking request command by the deceleration ratio α, and set up the computed value (Fa*/α) as new target regenerative braking force Fa* in step S211. That is, the target regenerative braking force Fa* set up by the brake ECU110 is corrected using the deceleration ratio α.

Then, in step S22, the hybrid ECU8 operates the motor 2 as a generator so that the regenerative braking force as close to the target regenerative braking force Fa* as possible is generated, while setting the target regenerative braking force Fa* after being corrected as an upper limit. In this case, the brake ECU110 controls the switching chip of an inverter so that the power-generation current flowing through the motor 2 follows the current corresponding to the target regenerative braking force Fa*. That is, the electricity supplied to the motor 2 is controlled with the control amount (current value) corresponding to the corrected target regenerative braking force Fa*. Then, in step S23, the hybrid ECU8 calculates the actual regenerative braking force (referred to as the actual regenerative braking force Fa) generated by the motor 2 based on the power-generation current and the power-generation voltage of the motor 2 in step 23, and multiplies this actual regenerative braking force Fa by the deceleration ratio α and sets up the computed value (Fa×α) as the new actual regenerative braking force Fa in step S231. This actual regenerative braking force Fa is the actual regenerative braking force Fa reported to the brake ECU110, and is not the actually generated regenerative braking force. This is for the correction of the actual regenerative braking force Fa not to affect the calculation of the target friction braking force Fb*. Then, the hybrid ECU8 transmits the information showing the actual regenerative braking force Fa to the brake ECU110 in step S24.

When receiving the information showing the actual regenerative braking force Fa transmitted from the hybrid ECU8, the brake ECU110 calculates the target friction braking force Fb* by subtracting the actual regenerative braking force Fa from the target braking force F*(=F*−Fa) in step S15, and calculates the target fluid pressure P* common to the wheel cylinders for four wheels set up corresponding to the target friction braking force Fb* in step S16. The brake ECU110 controls the drive currents of the pressuring linear control valve 67A and the depressuring linear control valve 67B so that the wheel cylinder pressure becomes equal to the target fluid pressure P* in step S18, without performing the processing in step S17 in the above-mentioned embodiment.

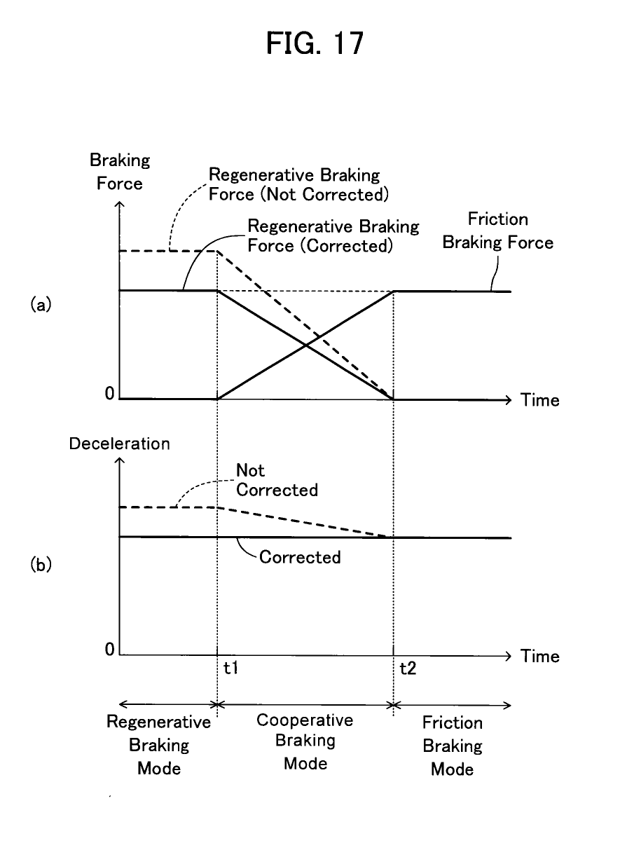

In accordance with this modification, as shown in FIG. 17 (a), only the regenerative braking force generated by the motor 2 is corrected using the deceleration ratio α, and the friction braking force is not corrected. For this reason, as shown in FIG. 17 (b), the fluctuation of the deceleration of the vehicle body when the braking mode shifts from the regenerative braking mode to the friction braking mode can be suppressed. In addition, although the information which shows the deceleration ratio α is transmitted from the brake ECU110 to the hybrid ECU8 and the hybrid ECU8 corrects the target regenerative braking force Fa* in this modification, the brake ECU110 may correct the target regenerative braking force Fa* and transmit the corrected target regenerative braking force Fa* to the hybrid ECU8, alternatively. For instance, the brake ECU110 divides the target regenerative braking force Fa* by the deceleration ratio α, performs the correction to set the computed value as a new target regenerative braking force Fa*(Fa*=Fa*/a), and transmits the corrected target regenerative braking force Fa* to the hybrid ECU8. The hybrid ECU8 controls the regenerative braking force of the motor 2 based on this target regenerative braking force Fa*, and transmits the actual regenerative braking force Fa to the brake ECU110. The brake ECU110 multiplies the real regeneration braking force Fa transmitted from the hybrid ECU8 by the deceleration ratio α, sets the computed value (Fa×α) as a new actual regenerative braking force Fa, and thereafter calculates the target friction braking force Fb*(Fb*=F*−Fa). Thereby, the corrections of the target regenerative braking force Fa* can be prevented from affecting the calculation of the target friction braking force Fb*.

As mentioned above, although the brake control devices according to the embodiments and modification have been explained, the present invention is not limited to the above-mentioned embodiments and modification, and various modifications are possible for the present invention unless it deviates from the objective of the present invention.

For instance, although the brake control device according to the present embodiment is applied to a front-wheel-drive-type hybrid vehicle, it may be applied to a rear-drive-type or four-wheel-drive-type hybrid vehicle. Moreover, it is also applicable to an electric vehicle equipped only with a motor as a power source for running (it comprises no internal-combustion engine). That is, the present invention can be applied to any vehicles as long as the vehicles can generate regenerative braking force by a motor.

Moreover, in the brake regeneration cooperative control routine (FIG. 3), although the target fluid pressure P* is always corrected based on the deceleration ratio α, the correction of the target fluid pressure P* does not necessarily need to be performed always. For instance, the correction of the target fluid pressure P* can be started at the timing when switching from the regenerative braking mode to the cooperative braking mode, and the correction can be ended in response to the end of a brake operation.

What is claimed is:

1. A brake control device for a vehicle comprising:
a regenerative braking means for making a wheel generate a regenerative braking force by converting a kinetic energy of the rotating wheel into an electrical energy and collecting the electrical energy in a battery,
a friction braking means for making a wheel generate a friction braking force by a friction using a friction member, and
a mode switch means for shifting a braking mode from a regenerative braking mode which generates a required braking force according to an amount of a brake operation only by said regenerative braking force to a friction braking mode which generates said required braking force only by said friction braking force,
wherein:
a gap index acquisition means for acquiring a gap index which shows a gap of a correlation between a required braking force and an actually obtained deceleration of a vehicle body at the time of an execution of said friction braking mode from a basis which is a correlation between a required braking force and an actually obtained deceleration of the vehicle body at the time of an execution of said regenerative braking mode, and
a braking force correction means for correcting a target value of said friction braking force or said regenerative braking force based on said gap index so that said gap decreases.

2. The brake control device for a vehicle, according to claim 1, wherein:
said gap index acquisition means acquires, as said gap index, a deceleration ratio which shows the ratio of a deceleration acquired at the time of the execution of said regenerative braking mode and a deceleration acquired at the time of the execution of said friction braking mode under a common required braking force condition.

3. The brake control device for a vehicle, according to claim 2, comprising:
a brake operation retention evaluation means for judging whether the braking mode is shifted from said regenerative braking mode to said friction braking mode in a status that a brake operation is retained constant,
wherein:
said gap index acquisition means calculates, as said deceleration ratio, the ratio of the deceleration acquired at the time of the execution of said regenerative braking mode and the deceleration acquired at the time of the execution of said friction braking mode at the time of a transition from said regenerative braking mode to said friction braking mode, when it is judged that the braking mode is shifted from said regenerative braking mode to said friction braking mode in a status that a brake operation is retained constant.

4. The brake control device for a vehicle, according to claim 2, comprising:
a regeneration deceleration property acquisition means for sampling a plurality of data which shows a correlation of a required braking force and an actually obtained deceleration of a vehicle body to acquire a regeneration deceleration property which shows the property of an actual deceleration over a required braking force at the time of the execution of said regenerative braking mode, and
a friction deceleration property acquisition means for sampling a plurality of data which shows a correlation of a required braking force and an actually obtained deceleration of a vehicle body to acquire a friction deceleration property which shows the property of an actual deceleration over a required braking force at the time of the execution of said friction braking mode,
wherein:
said gap index acquisition means calculates said deceleration ratio based on said regeneration deceleration property and said friction deceleration property.
